(19) United States
(12) Patent Application Publication
(10) Pub. No.: US 2005/0119991 A1
(43) Pub. Date: Jun. 2, 2005

(54) Access administration system and method

(76) Inventors: David Delgrosso, Naperville, IL (US); Fraser Orr, Naperville, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/932,979

(22) Filed: Sep. 2, 2004

Related U.S. Application Data
(60) Provisional application No. 60/499,772, filed on Sep. 3, 2003.

(51) Int. Cl. G06F 7/00

(52) U.S. Cl. 707/1

(57) ABSTRACT

An access administration system and method is disclosed using authentication data.

### CROSS-REFERENCE TO RELATED APPLICATIONS

This application claims the benefit of U.S. Provisional Application Ser. No. 60/499,772, filed Sep. 3, 2003, and herein incorporated by reference.

### TECHNICAL FIELD

The present invention relates to access administration systems and methods, and in particular, to access administration systems and methods using authentication data.

### DETAILED DESCRIPTION

While this invention is susceptible of embodiments in many different forms, there will herein be described in detail a preferred embodiment of the present invention with the understanding that the present disclosure is to be considered as an exemplification of the principles of the invention and is not intended to limit the broad aspect of the present invention to the embodiment illustrated.

Central Q

Central Q is a system for the centralized administration of resources, both physical (such as door and room access) and virtual (such as log in to computers, networks and web sites.) It consists of a core administration tool and a group of optional, pluggable modules that control different types of access. It allows both the administration and monitoring of access to various resources.

It has the following features:
Authentication of users based on biometric identification (using a variety of fingerprint devices.)
Groups of users which can be assigned to individuals, granting template set ups for permissions. (For example, janitorial staff might be a group allowed access to all doors but no computer systems. The Janitorial group can be set up once, and then assigned to all janitorial staff, meaning complex set ups are not necessary for each individual.)
Security configurations. Different occasions call for different security configurations. Each security parameter is also assigned a configuration group. For example, some government facilities might control access differently depending on the terrorist threat level set by the Department of Homeland security. By configuring these differences, the security configuration can be changed with the click of a button, rather than having to go through the whole system piecemeal.
Centralized control of access to all resources, physical and virtual in one place.
Centralized control of password lists.
Each user can readily configure their own Central Q configuration, such as changing passwords, adding their own scripts etc. Obviously they can't give themselves permission to use resources which they are not allowed to use.
Administrator control, that is, control over which administrator can make what changes.
Multiple levels of control, that is, Central Q servers are controlled in a chain of authority, from individual central q servers on individual machines, up through local office control, all the way up to head office control.
Distribution of both authorization tokens (passwords) and other resources. For example, Appli Q scripts can be distributed through Central Q.
Transaction log facilities built in.
Reporting facilities built in.
Use of different kinds of database back ends.
Configurable security parameters
Optional automatic rotation of passwords. When a method can be supplied to Central Q, the system can be set to automatically change passwords on various systems on different cycles. This is not generally a problem for users, because they use their fingerprint to access the resource, however, it does greatly increase security. Passwords can be rotated daily, weekly, monthly, or on every use. Of course, passwords can also be set to not rotate at all, in such cases where non biometric access is required. However, obviously that is a security threat.
Automated password crack tests. Central Q automatically audits the passwords users supply to find weak passwords, and eliminate them from the system.
Access to Central Q itself is controlled by biometric access.
   Central Q includes a set of pluggable modules that provide control to specific Resources. The architecture is extensible, however, the following modules will be available initially.
Pass Q
   This is a product to allow the user of a computer to log in to that computer (and any associated domain controllers, work groups or other networks) using only their fingerprint.
Appli Q
   Appli Q is a product for adding functionality, including biometric functionality on top of already existing applications without having to change the actual software itself. It will be described in much greater detail below.
QRL
   QRL is an add on for web servers and web browsers to allow web servers to accurately determine who is accessing a web page.

Unlike traditional methods, this system does not store a user name and password locally on the client (web browser) machine, rather it gathers a unique fingerprint, which is analyzed at the server to determine who this person is. This allows a very high level of certainly as to who the person requesting the web page is, and whether they are authorized to view it.

This process is design to be extremely easy to integrate into existing web infrastructures, in particular, it is a simple ISAPI filter, or Apache module, that can be easily added, requiring only that a few changes be made to enable the biometrics. All biometric data is translated into password data on the fly, so that no authentication changes are required by the web site coder.

Security is further enhanced by mixing in random and session data into the encrypted data packets sent over the Internet from the client. This defeats a number of important security vulnerabilities that such a system might have otherwise.

QRL is designed to integrate cleanly and easily into Central Q to allow direct control from Central Q of what web pages a person is allowed to view.
Door Q
   Door Q is a product to control access to various doors. It uses a biometrics fingerprint reader to determine who a person is, and if they are authorized to open that door. If so, depending on configuration in Central Q, stating who may access the door, when, and in what system configuration, then the door will be opened.
   Door Q can be directly integrated into When Q, to allow time and attendance tracking of employees.
When Q
   When Q is a time and attendance tracking tool. It tracks when a person starts and ends work, and interfaces with both Central Q, to determine the identity of the individual, and various reporting and payroll systems to provide that functionality.
      Appli Q

Appli Q is a system to add functionality, including biometric functionality, to an existing application without changing the application itself. Note that application here can refer to a regular computer application running on a local machine, DOS based application, an application running over a terminal emulator connection, a thin client application or a web based application (that is a web page or set of web pages.)

It does this using the following components:
A recognizer: A recognizer is a tool that recognizes when an application is started, is finished, or reaches a particular state, such as a particular screen or dialog with in the application.
   There are a variety of different recognizers used for different application domains, for example, the Windows recognizer watches and recognizes states and state changes in windows applications, the DOS recognizer does so for DOS programs, the Telnet recognizer does so for telnet like programs, and the web recognizer does so for web based programs.
An abstractor: This is a tool that watches text based applications such as DOS or Telnet, to watch of commonalities. It does this by watching the user operate a system, and finding the commonalities between different screens (and where there is variability, such as data fields.) The recognizer for these corresponding tools can then be used to identify these states of the user interface.
An executor: An executor is a tool that executes a series of actions against the application, according to a user defined program. The executor can request data from Central Q, based on any or all of the following criteria: the application, the application state, the computer the system is running on, the login name of the user, a fingerprint collected by the user, or various other criteria.
   In addition the recognizer can be executed from the executor, to make control flow decisions based on what screen is shown in a response.
An event handler: An event handler is a tool that runs the executor with a particular program when the recognizer recognizes a certain state.
A recorder too: is a tool that can be activated to watch a user performing certain actions, and based on these actions reproduce a program that would duplicate these actions. However, at various points during the recording, the recorder can be paused to indicate that certain information should be obtained at that point in the program from the Central Q repository.
A programming environment: is a integrated development environment that allows the user to customize the various programs, including setting break points, stepping through, adding dialogs and so forth, to enable the development, debugging of, improvement or original design of the programs. This environment can be used to edit and manage scripts recorded by the recorder.

The various components of Appli Q interface with Central Q for the proper distribution of the programs, recognition set ups and so forth.

As a simple example, a script might be defined to log in to a certain web site. To record such a script, the user would go to the web site, and start the recorder. They would first click the user name field, then click a special key to go back to the recorder. The recording would be paused. At this point the user indicates to the recorder that they will be entering a user name field, which should normally be obtained from the Central Q repository, based on a fingerprint. The recording would resume, with the user name filled in. Next, the user would go to the password field, and click back to the recorder, this time indicating that a password should be obtained. Then the recording is resumed, the user clicks the LOGIN button and then stops recording. This recording would appear in a script like this:

Sub Login_Yahoo( )

SelectTextBox “UserName”
Type GetFromCentralQ(“UserName”, “http://www.yahoo.com”,

ContextEingerprint( ))

SelectTextBox “Password”
Type GetFromContext(“Password”, “http://www.yahoo.com”,

ContextFingerprint( ))

ClickBotton “LOGIN”

End Sub

It also defines an entry in the event handler like this:

On Event URL = “www.yahoo.com”

GetFingerprintToContext( )
Login_Yahoo( )

End Sub

Finally, it defines a new password set in Central Q (that is meta data)
“http://www.yahoo.com ”, username, password

And fills this value in for the current user (that is actual data)

Please note that although Appli Q was motivated by the need to add biometrics to existing applications, it can be used completely without biometrics to add enhanced functionality to applications.

Member Q

MemberQ is a set of applications defined to introduce biometrics into the banking industry. It is composed of several components: These components taken together form Member Q.

Appli Q

Appli Q can be used in this situation to add biometric functionality to existing bank teller software. This allows customers to identify themselves to the bank based on fingerprint rather than name or drivers' license.

Lobby Q

Lobby Q is a tool for managing lines in a bank (or other facility) lobby. When a customer arrives, they check into the line using their fingerprint. This is sufficient in itself, however, it there may optionally be a front desk person who determines the needs of the customer, and places them on an appropriate line.

As an appropriate representative becomes available, the person's name can be called, or optionally displayed on a marquee. The customer service representative initiates this action by clicking a button on an application on their system, which gives them prior warning, and allows them to do a little research on the customer before they arrive at the window.

Lobby Q is also integrated in with the execution engine in Appli Q meaning that when a particular customer arrives arbitrary actions can be set up. For example, if a known criminal comes in, an alarm can be set to security personnel, or if a particularly important customer comes in they might jump the line, or have the bank manager come greet them personally.

ATM-Q

ATM Q is a system of biometrics to replace the security tokens currently used in ATMs.

Depending on the configurations, ATM Q can use any of the following combinations to identify people:
Card and fingerprint
PIN and fingerprint
Two fingerprints
Fingerprint and signature.

These two security tokens can be used as a plug in replacement for the present system of card and PIN code.

Drive Up Q

Drive Up Q is a tool for identifying customers at a drive up bank. It operates much as Appli Q applied to banking teller software, however, it uses fingerprint readers hardened for the external environment.

While the specific embodiments have been illustrated and described, numerous modifications come to mind without significantly departing from the spirit of the invention.

1. An access administration system as substantially described above.

2. An access administration method as substantially described above.

3. A system comprising a Central Q system, an Appli system, and a Member Q set of applications.
